(19) United States
(12) Patent Application Publication
(10) Pub. No.: US 2013/0252699 A1
(43) Pub. Date: Sep. 26, 2013

(54) WAGERING GAME HAVING MOVING EVALUATION WINDOW WITHIN SYMBOL ARRAY

(71) Applicant: WMS GAMING INC., Waukegan, IL (US)

(72) Inventors: Jeffry L. Nauman, Yorkville, IL (US); Jeremy M. Hornik, Chicago, IL (US); Patrick M. Dixon, Chicago, IL (US)

(73) Assignee: WMS Gaming Inc., Waukegan, IL (US)

(21) Appl. No.: 13/783,521

(22) Filed: Mar. 4, 2013

Related U.S. Application Data
(60) Provisional application No. 61/613,794, filed on Mar. 21, 2012.

(51) Int. Cl. G07F 17/34

(52) U.S. Cl. CPC G07F 17/34
USPC 463/20

(57) ABSTRACT

A method for conducting a wagering game includes receiving a wager and displaying a plurality of symbol-bearing reels. A first set of reels to be evaluated is highlight, spun, and stopped such that a first randomly selected outcome is indicated. The first outcome is evaluated to determine if it is a winning outcome. In response to a winning outcome, a second set of reels to be evaluated is highlighted. The second set of reels includes at least one of the reels of the first set of reels and one of the reels that is adjacent to the first set of reels. The one of the reels that is adjacent to the first set of reels is stopped such that a second randomly selected outcome is indicated by the second set of reels. The second outcome is evaluated to determine if the second outcome is a winning outcome.

### CROSS-REFERENCE TO RELATED APPLICATION

This application claims the benefit of U.S. Provisional Application No. 61/613,794, filed Mar. 21, 2012, which is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to wagering game machines and, more particularly, to wagering game machines with moving evaluation windows within a symbol array.

### BACKGROUND

Gaming machines or terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing terminals and the expectation of winning each terminal is roughly the same (or believed to be the same), players are most likely to be attracted to the more entertaining and exciting terminal. As a result, wagering game machine operators strive to employ the most entertaining and exciting machines available, because such machines attract frequent play and provide increased profitability for the operators.

### SUMMARY OF THE INVENTION

A method for conducting a wagering game via a gaming terminal includes receiving, via an input device, a wager to play the wagering game. A plurality of symbol-bearing reels is displayed on one or more display devices arranged in a plurality of adjacent columns. A first set of the reels to be evaluated is highlight on the one or more display devices. The first set of the reels are spun and stopped such that a first randomly selected outcome is indicated by the first set of the reels. The first outcome is evaluated to determine if the first outcome is a winning outcome. In response to the first outcome being a winning outcome, a second set of reels to be evaluated is highlighted. The second set of reels includes at least one of the reels of the first set of reels and one of the reels that is adjacent to the first set of reels. The one of the reels that is adjacent to the first set of reels is stopped such that a second randomly selected outcome is indicated by the second set of reels. The second outcome is evaluated to determine if the second outcome is a winning outcome.

A method for conducting a wagering game via a gaming terminal includes receiving, via an input device, a wager to play the wagering game. N symbol-bearing reels are displayed on one or more display devices. A first set of the N reels to be evaluated is highlighted on the one or more display devices. The first set of the N reels at least includes first and second ones of the N reels. The N reels are spun and the first set of the N reels is stopped such that a first randomly selected outcome is indicated by the first set of the N reels. The first outcome is evaluated to determine if the first outcome is a winning outcome. In response to the first outcome being a winning outcome a second set of the N reels to be evaluated is highlighted. The second set of the N reels at least includes the second one of the N reels and an additional one of the N reels. The additional one of the N reels is stopped such that a second randomly selected outcome is indicated by the second set of the N reels. The second outcome is evaluated to determine if the second outcome is a winning outcome.

A method for conducting a wagering game via a gaming terminal includes receiving, via an input device, a wager to play the wagering game. An array of symbol positions arranged in a plurality of columns is displayed on one or more display devices. A plurality of symbols is randomly distributed such that each of the symbol positions in a first portion of the array of symbol positions is associated with one or more of the plurality of symbols thereby forming a first partial-outcome. The first partial-outcome is evaluated to determine if the first partial-outcome is a winning partial-outcome. In response to the first partial-outcome being a winning partial-outcome a first award is provided. A portion of the plurality of symbols is randomly distributed such that each of the symbol positions in a first one of the columns adjacent to the first partial-outcome is associated with one or more of the plurality of symbols. A portion of the first partial-outcome and the first one of the adjacent columns forms a second partial-outcome. The second partial-outcome is evaluated to determine if the second partial-outcome is a winning partial-outcome.

A method for conducting a wagering game via a gaming terminal including receiving, via an input device, a wager to play the wagering game. A plurality of symbol-bearing reels arranged in a plurality of adjacent columns is displayed on one or more display devices. One of the reels is a bonus reel bearing bonus symbols. A first portion of the reels to be evaluated is highlighted on the one or more display devices. The first portion of the reels does not include the bonus reel. The reels are spun and the first portion of the reels is stopped such that a first randomly selected outcome is indicated by the first portion of the reels. The first outcome is evaluated to determine if the first outcome is a winning outcome. In response to the first outcome being a winning outcome a first award is provided. A second portion of the reels to be evaluated is highlighted. The second portion of the reels does not include the bonus reel. The second portion of the reels includes at least one of the reels of the first portion of the reels and one of the reels that is adjacent to the first portion of the reels. The one of the reels that is adjacent to the first portion of the reels is stopped such that a second randomly selected outcome is indicated by the second portion of the reels. The second outcome is evaluated to determine if the second outcome is a winning outcome. In response to the second outcome being a winning outcome, the bonus reel is activated.

A gaming system includes at least one input device, at least one display device, at least one processor, and at least one memory device. The at least one memory device stores instructions that, when executed by the at least one processor, cause the gaming system to receive a wager to play a wagering game and to display a plurality of symbol-bearing reels arranged in a plurality of adjacent columns. The at least one memory device further stores instructions that, when executed by the at least one processor, cause the gaming system to highlight a first set of reels to be evaluated, to spin the reels and stop the first set of reels such that a first randomly selected outcome is indicated by the first set of reels, and to evaluate the first outcome to determine if the first outcome is a winning outcome. In response to the first outcome being a winning outcome, the at least one memory device further stores instructions that, when executed by the at least one processor, cause the gaming system to (i) highlight a second set of reels to be evaluated, where the second set of reels includes at least one of the reels of the first set of reels and one of the reels that is adjacent to the first set of reels, (ii) stop the one of the reels that is adjacent to the first set of reels such that a second randomly selected outcome is indicated by the second set of reels, and (iii) evaluate the second outcome to determine if the second outcome is a winning outcome.

Additional aspects of the present disclosure will be apparent to those of ordinary skill in the art in view of the detailed description of various implementations, which is made with reference to the drawings, a brief description of which is provided below.

### BRIEF DESCRIPTION OF THE DRAWINGS

FIG. 1 is a perspective view of a free-standing gaming terminal according to some aspects of the present disclosure;

FIG. 2 is a schematic view of a gaming system according to some aspects of the present disclosure;

FIG. 3 is an image of an exemplary basic-game screen of a wagering game displayed on a gaming terminal according to some aspects of the present disclosure;

FIGS. 4A-4J are screen shots of a display of the free-standing gaming terminal of FIG. 1 according to various aspects of the present disclosure;

FIG. 5 is a screen shot of a display of the free-standing gaming terminal of FIG. 1 according to various aspects of the present disclosure.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the disclosure is to cover all modifications, equivalents, and alternatives falling within the spirit and scope of the present invention as defined by the appended claims.

### DETAILED DESCRIPTION

While this disclosure is susceptible of embodiment in many different forms, there is shown in the drawings and will herein be described in detail preferred embodiments of the disclosure with the understanding that the present disclosure is to be considered as an exemplification of the principles of the disclosure and is not intended to limit the broad aspect of the disclosure to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

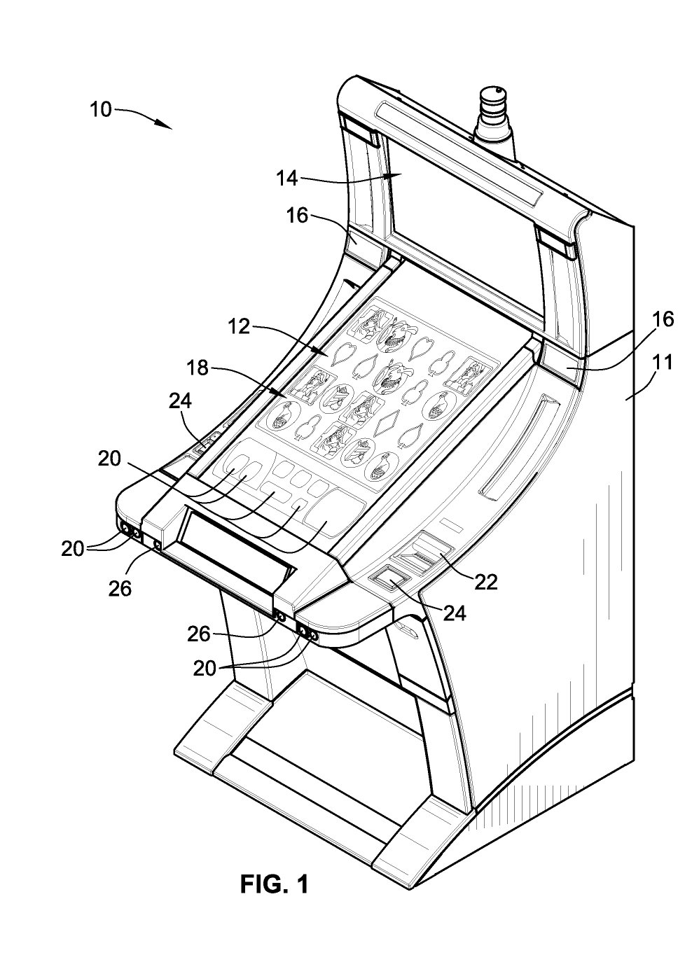

Referring to FIG. 1, there is shown a gaming terminal 10 similar to those used in gaming establishments, such as casinos. With regard to the present disclosure, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0062196 and US2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

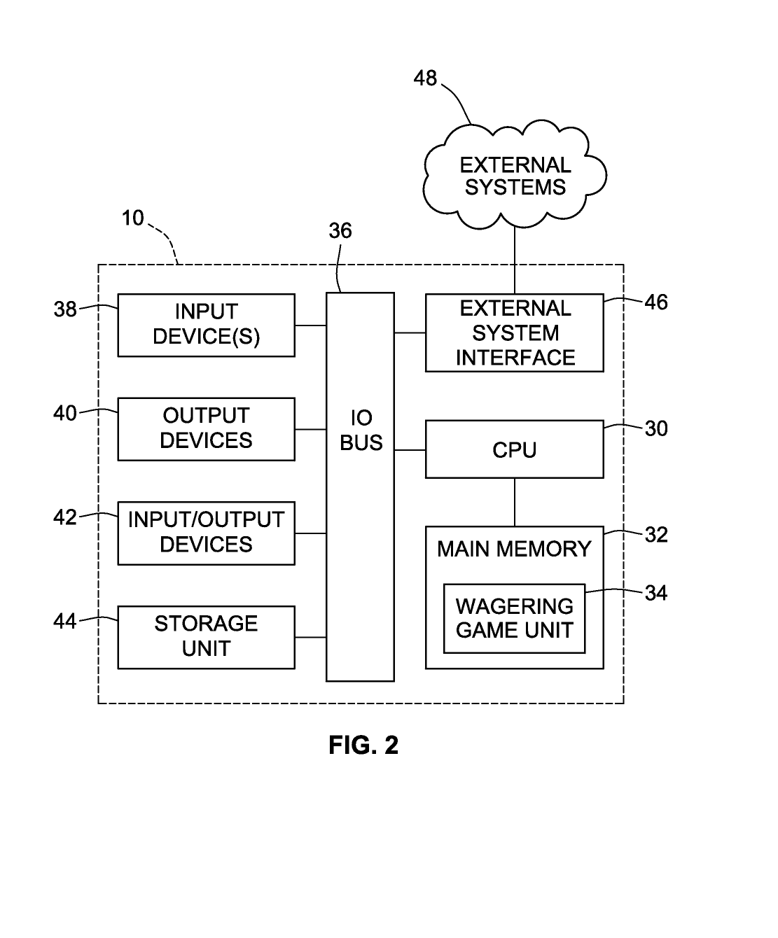

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

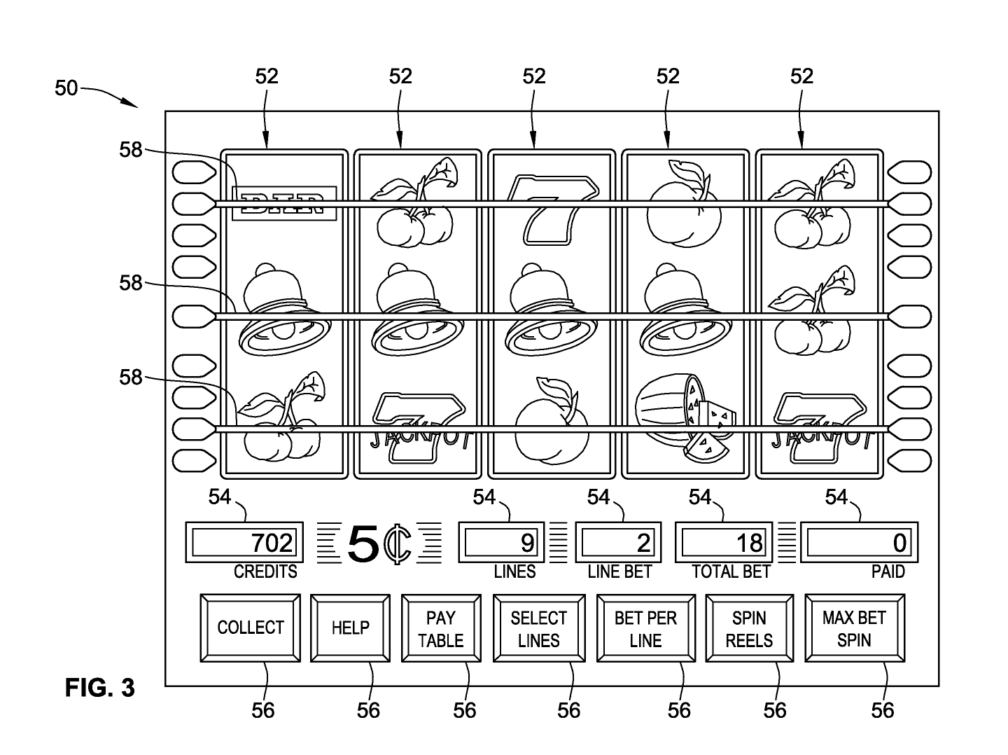

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

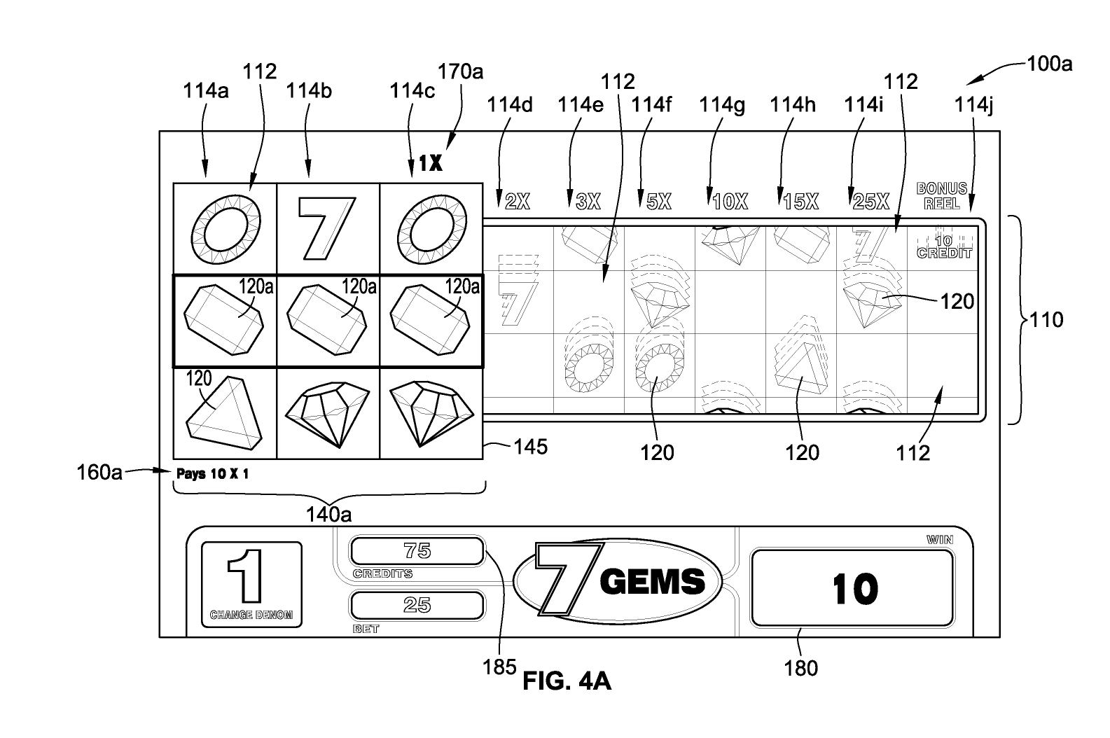

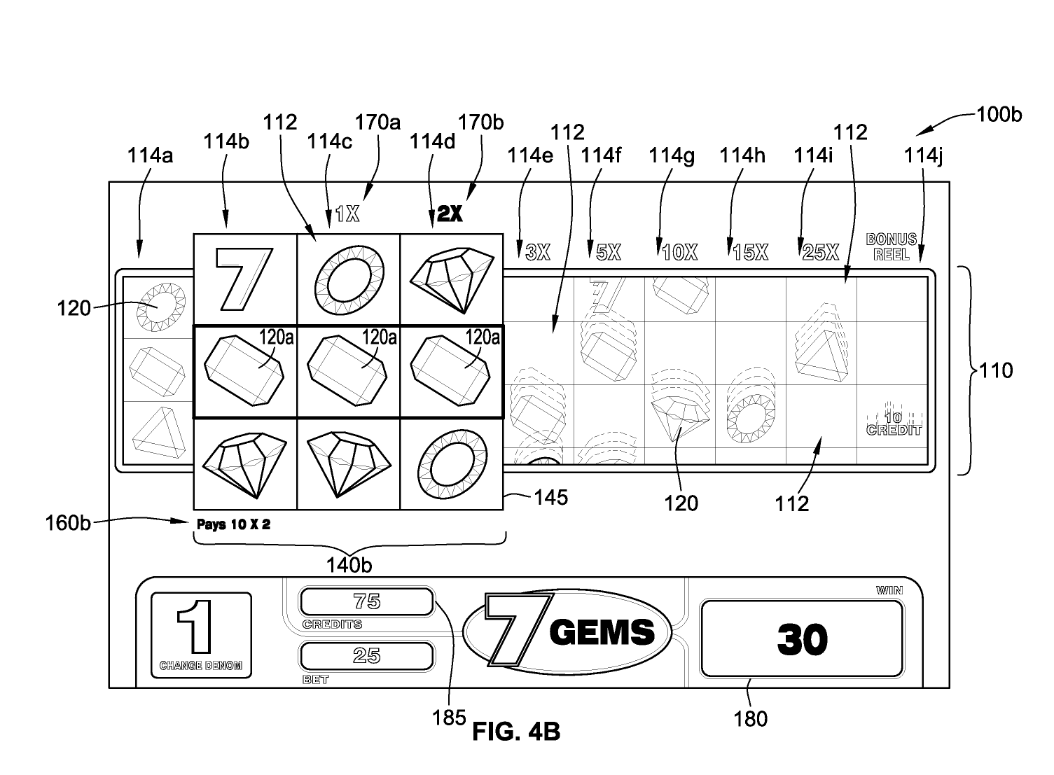

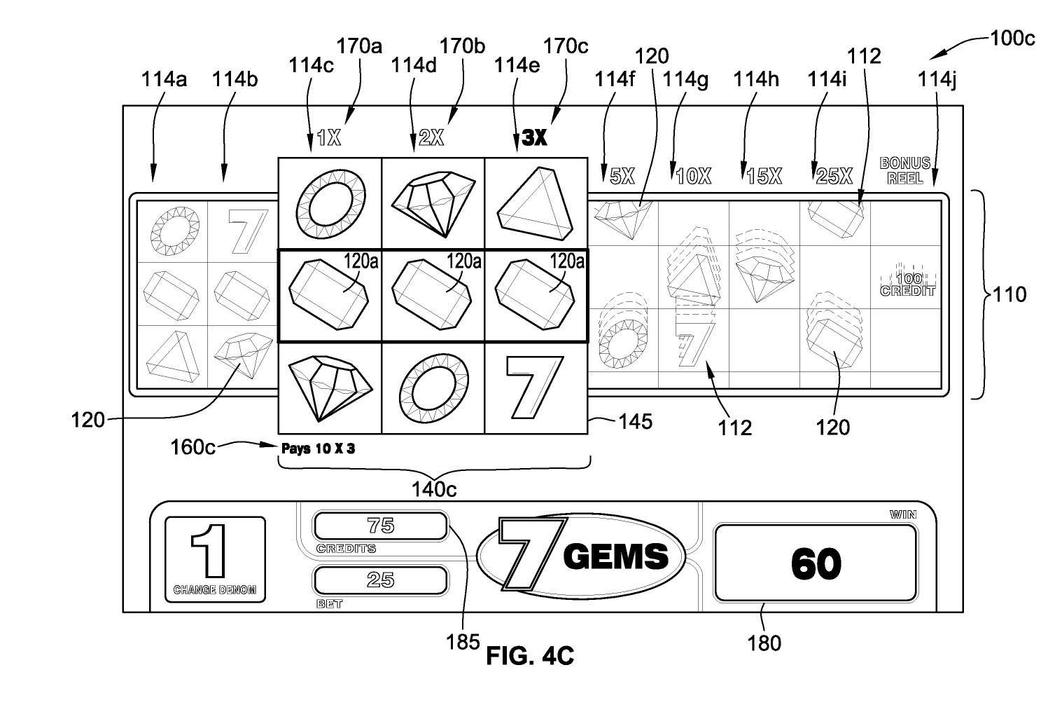

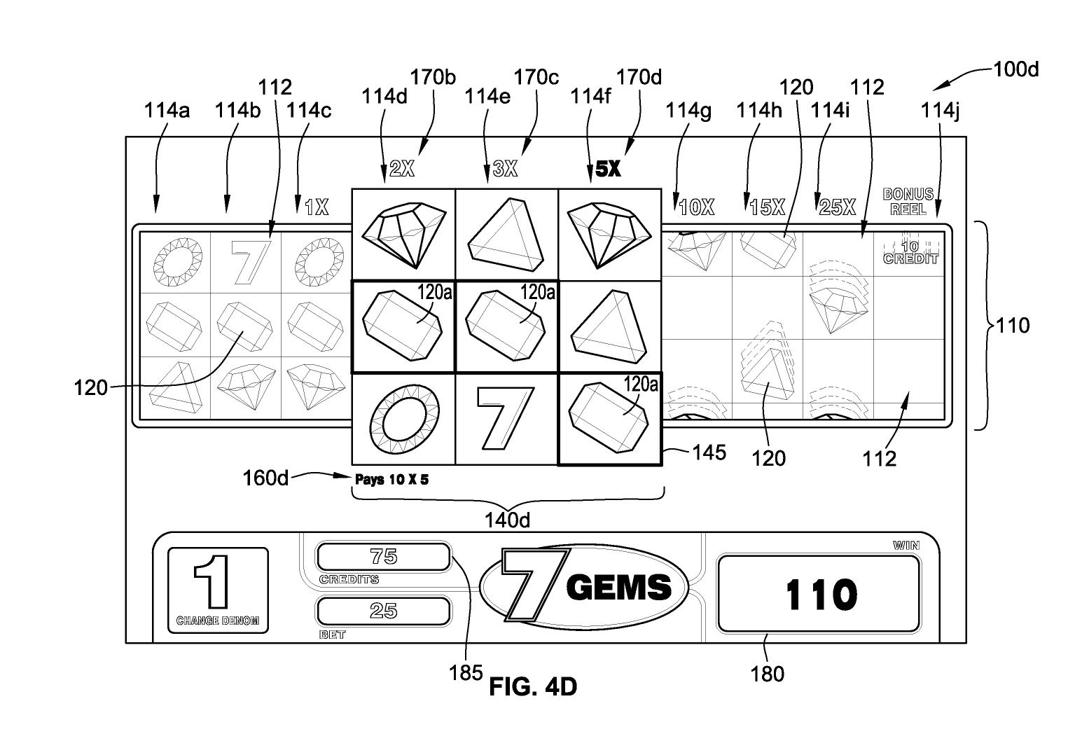

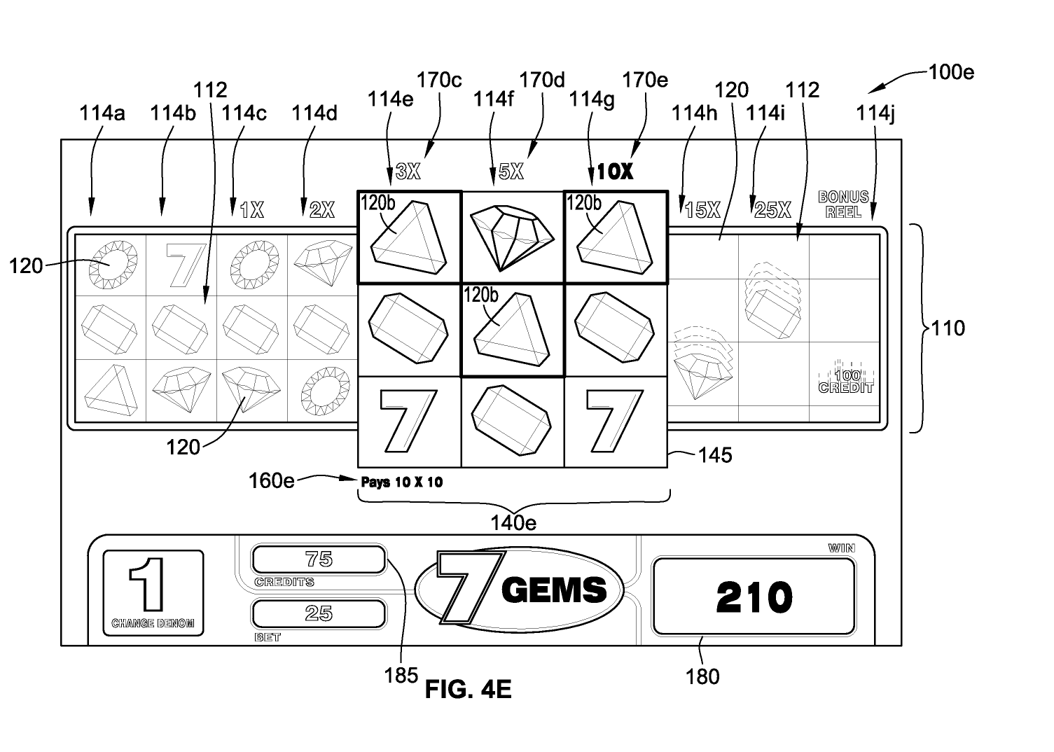

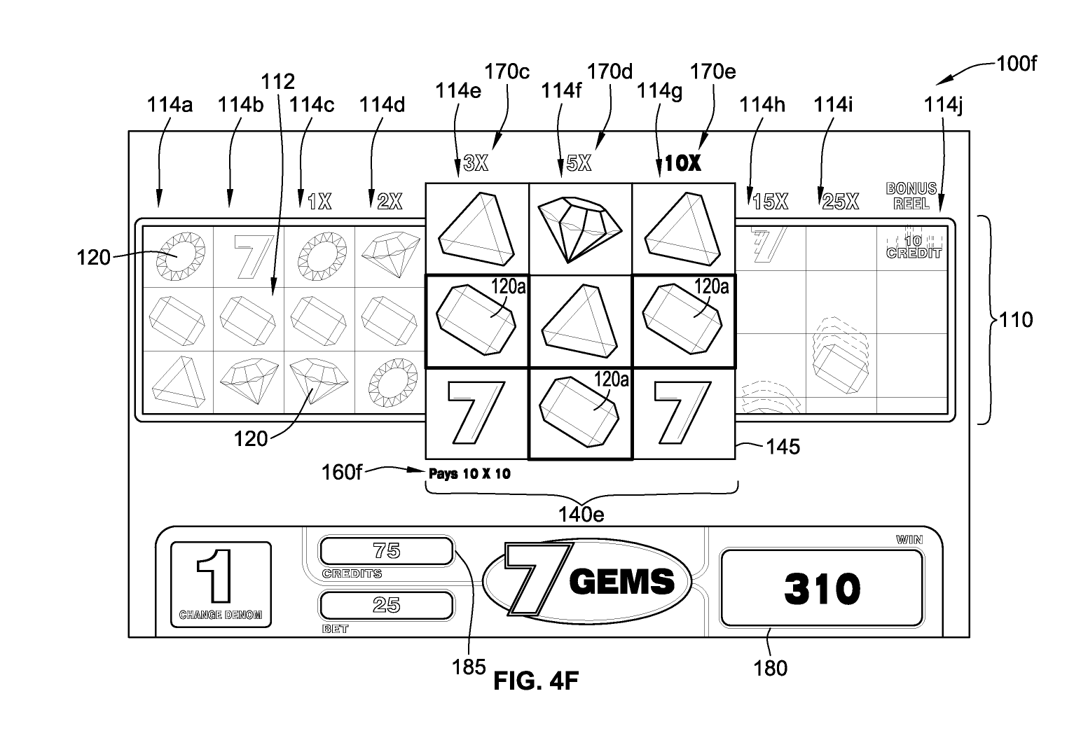

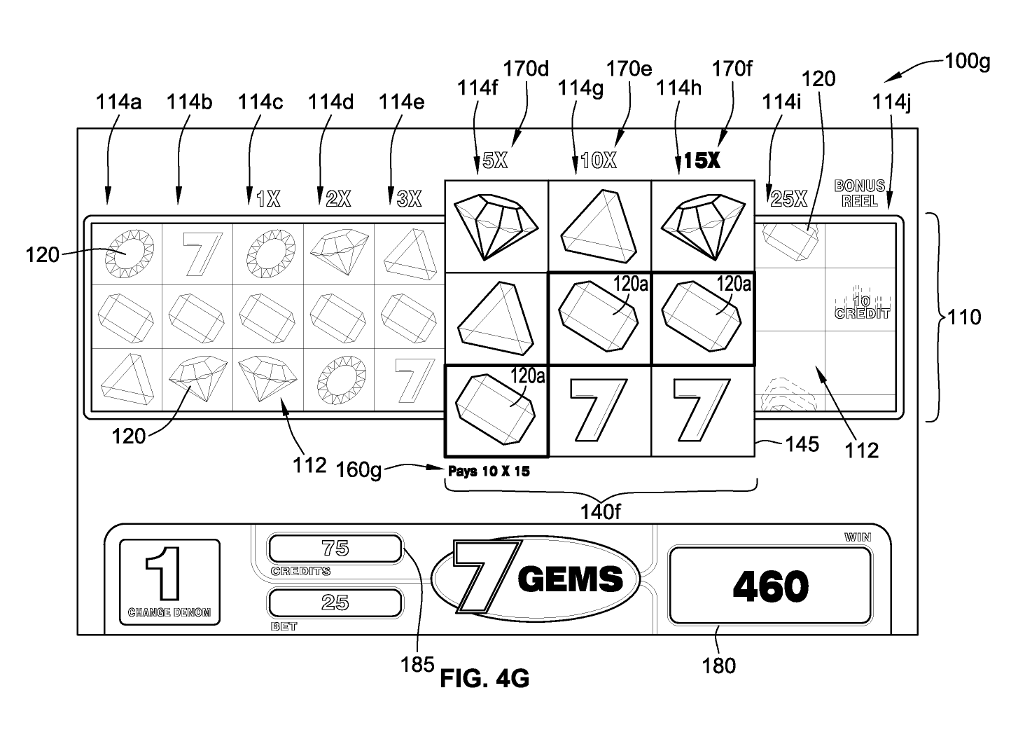

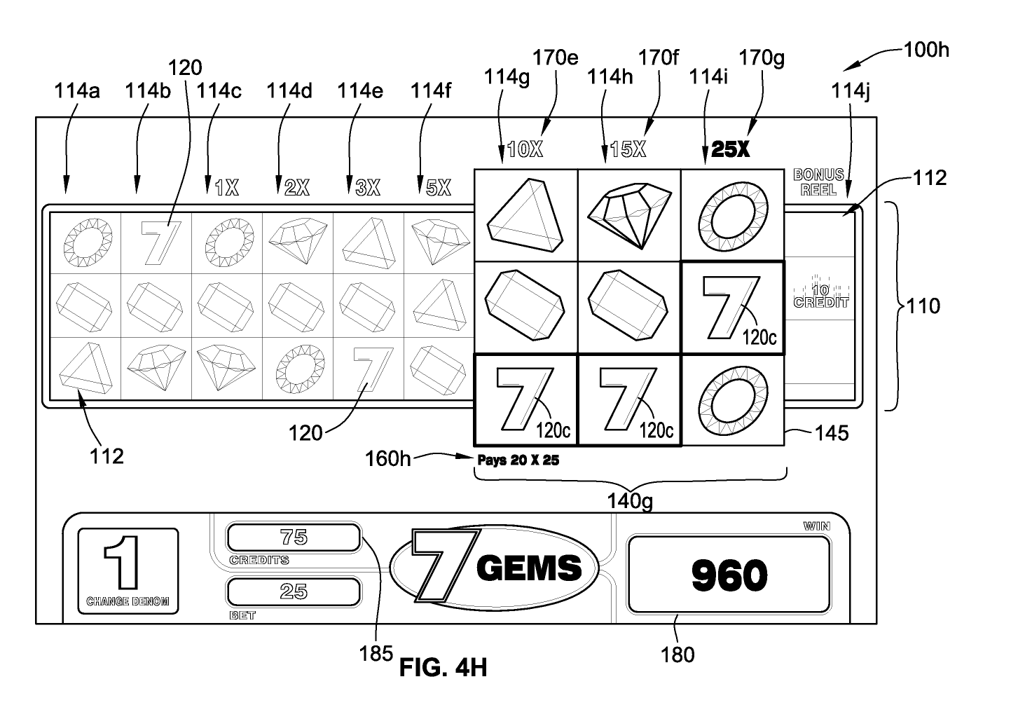

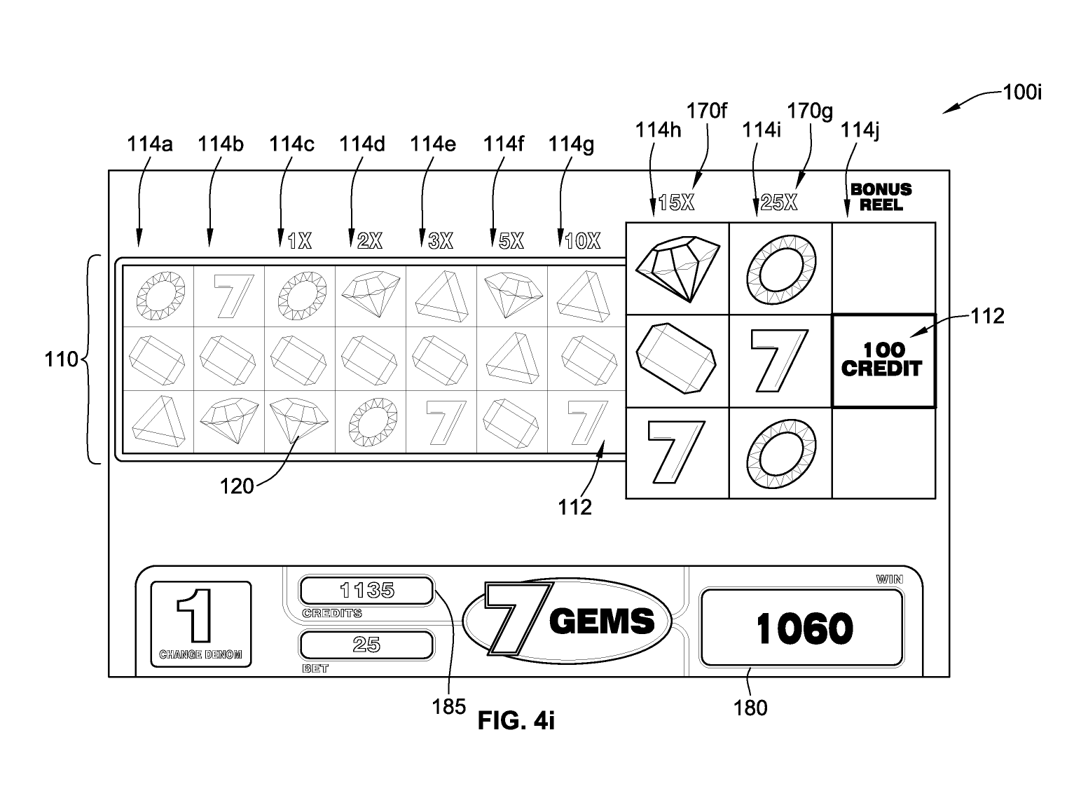

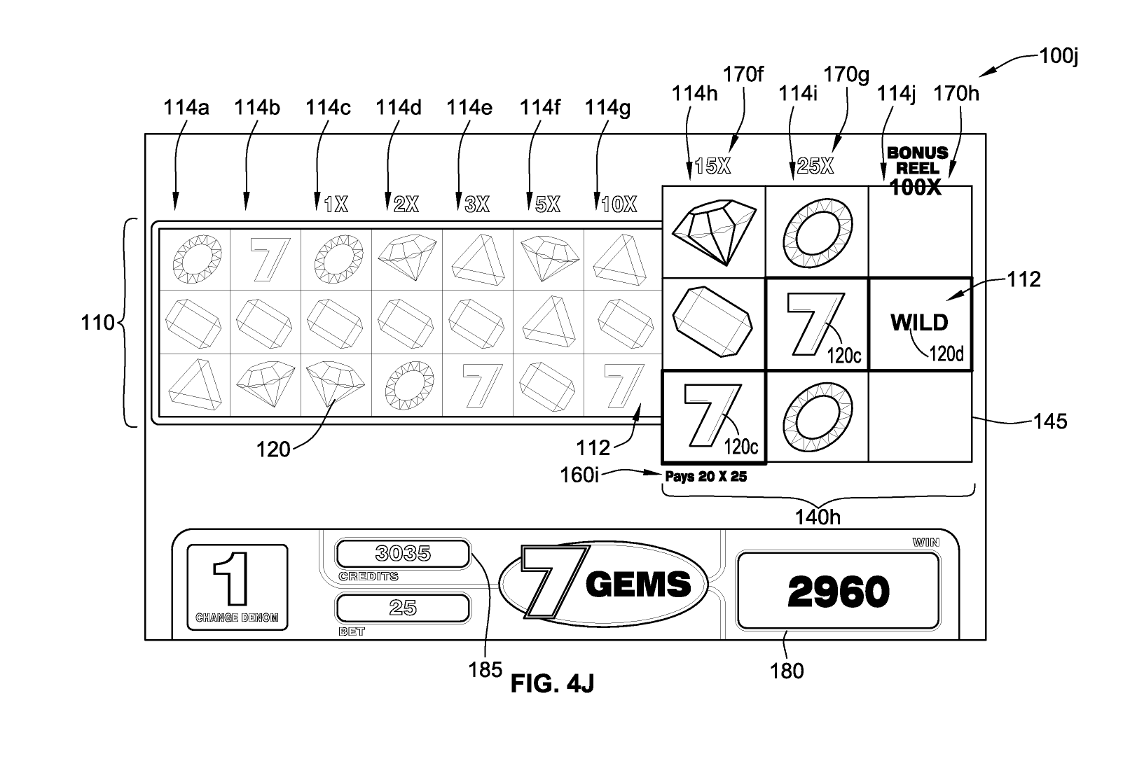

The primary display area 12 and/or the secondary display area 14 can be used for displaying one or more portions of a wagering game. Referring generally to FIG. 4A-4J, screen shots 100a-100j of the primary display area 12 and/or the secondary display area 14 illustrate one play of a wagering game according to some aspects of the disclosed concepts. Generally, one play of the wagering game provides a first random sub-outcome that is evaluated (FIG. 4A). If the first sub-outcome is a winning outcome, then the play of the wagering game continues providing a player with an opportunity to win additional credits and/or other awards (e.g., multipliers, free plays, etc.) during the same play of the wagering game (e.g., without having to make an additional wager). Continuation of the play of the wagering game can include moving and/or sliding an evaluation window one reel to the right such that the evaluation window encompasses a second sub-outcome to be evaluated. The second sub-outcome includes a portion of the first sub-outcome and the outcome of one new/additional reel (FIG. 4B). If the second sub-outcome is also a winning outcome, then the play continues (FIGS. 4C-4J) in the same manner until a non-winning outcome is achieved (not shown) or until the evaluation window reaches the last reel in the array of reels/columns (FIGS. 4I and 4J). Any awarded/achieved credits can be paid to the player after the evaluation window slides and/or moves all the way to the right or until a non-winning sub-outcome is achieved.

A more specific description of the above general concepts is now provided. Referring specifically to FIG. 4A, the screen shot 100a includes an array of symbol positions 110 used in conducting the wagering game. The array of symbol positions 110 is a 3×10 matrix of symbol positions 112 arranged in ten columns 114a-j and three rows (i.e., thirty symbol positions 112). The array of symbol positions 110 is formed by a plurality of symbol-bearing reels such that each of the columns 114a-j is occupied by a single one of the reels and each of the reels bears at least a portion of a plurality of symbols 120. The symbol bearing reels can be mechanical reels, displayed simulated reels, or a combination thereof. While the array of symbol positions 110 is shown as including 10 columns 114a-j and three symbol positions 112 per column (i.e., three rows of symbol positions), any number of columns and rows can be provided. For example, the array of symbol positions can include 4, 5, 6, 7, 10, 20, n, etc. columns with 1, 2, 3, 5, 10, m, etc. rows.

While the gaming terminal 10 (FIG. 1) conducts a play of the wagering game, each of the columns 114a-j, or each of the symbol-bearing reels, spins or illustrates a simulated spin to appear as if each of the columns 114a-j is spinning prior to displaying an outcome of symbols. Some of the displayed symbols 120 are shown in FIG. 4A (and throughout the figures) at least in partial phantom to illustrate that some of the symbols 120 (e.g., the symbols 120 in columns 114d-j) are moving and not fixed within the array of symbol positions 110 at the moment illustrated in the screen shot 100a. Generally, symbols in columns to the right of an evaluation window 145 are spinning, while symbols in columns to the left of the evaluation window and symbols within the evaluation window 145 are stopped. The symbols in the lightest most reel within the evaluation window 145 initially spin and then stop to complete a sub-outcome as described in detail below.

At the beginning of a first play of the wagering game, all of the columns 114a-j spin and then stop spinning in a predetermined order (e.g., the first column 114a stops spinning first and displays its outcome, then the second column 114b stops and displays its outcome, etc.). As each column 114a-j stops spinning, a portion of a randomly selected outcome of symbols is displayed on the primary display area 12 and/or the secondary display area 14.

The first three columns 114a-c of the array of symbol positions 110 are highlighted to indicate that the first three columns 114a-c and the reels therein form a first set of reels 140a. As shown, the first set of reels 140a is highlighted by (1) surrounding the first set of reels 140a with the evaluation window 145 (e.g., a boarder) and (2) enlarging the first set of reels 140a such that the reels included in the first set of reels 140a are visually larger than the other reels in the array of symbol positions 110 (i.e., the reels in the fourth-tenth columns 114d j). The evaluation window 145 is shown as a thin, substantially uniform boarder surrounding the first set of reels 140a; however, the evaluation window 145 can be any type or size of boarder that highlights and/or distinguishes the first set of reels 140a from the rest of the reels.

The highlighting of the first set of reels 140a indicates that the first set of reels 140a are a first part of the entire array of symbol positions 110 that will stop spinning and be evaluated as a first sub-outcome. That is, the first set of reels 140a display the first sub-outcome that is evaluated prior to the other reels being evaluated and in some instances, prior to the other reels stopping. Depending on the outcome of the evaluation of the first set of reels 140a, the wagering game can proceed in many different ways. For example, if the evaluation of the first set of reels 140a results in a losing outcome (not shown), the wagering game can end without awarding anything to a player of the wagering game. In such an example, the rest of the reels (e.g., in columns 114d j) can stop spinning and display an outcome for those reels that the player could have achieved if the play continued. Alternatively, if the evaluation of the first set of reels 140a results in a winning outcome (as shown in FIG. 4A), the wagering game provides an award (e.g., 10 credits as shown in a credit win window 180 in FIG. 4A)) to a player of the wagering game and continues providing additional chances for award(s) such as credits.

Prior to the first sub-outcome being displayed in FIG. 4A, the first three reels were spun (mechanically or simulated video) and then stopped such that the first sub-outcome is indicated by the first set of reels 140a as shown in FIG. 4A. This first sub-outcome is evaluated to determine if it is a winning outcome. In the illustrated example, a winning outcome requires at least three like symbols in any positions within the evaluation window 145. As shown, there are three like symbols 120a within the evaluation window 145 in FIG. 4A, thus, the first sub-outcome is a winning outcome.

An indication 160a of the amount won based on the first sub-outcome is displayed below the evaluation window 145. In the instant example, the amount won is indicated to be 10×1. The “10” in the indication 160a refers to an amount of credits or coins associated with the symbols 120a that triggered the winning sub-outcome. That is, the symbols 120 can have different values associated therewith. The “1” in the indication 160a refers to a first multiplier 170a. As shown, the first multiplier 170a is a 1× multiplier, which means that any award achieved based on the first sub-outcome is multiplied by a 1× multiplier. The first multiplier 170a can vary based on various player inputs and/or randomly. For example, the first multiplier 170a can vary based on a wager amount, an amount of time playing the wagering game, a rate of game play, etc. This ten credits awarded based on the first sub-outcome is shown in the credit win window 180 as a total award amount of ten credits achieved thus far during the first play of the wagering game. The achieved credits are not added to the player's credits in the credit window 185 until the first play of the wagering game is concluded, such as, for example, as shown in FIGS. 4I and 4J, or until a sub-outcome results in a losing outcome (not shown).

Because the first sub-outcome indicated by the first set of reels 140a is a winning outcome, the first play of the wagering game continues as shown in FIG. 4B. Prior to displaying a second sub-outcome, the evaluation window 145 moves and/or slides one position or column to the right such that a second set of reels 140b (FIG. 4B) to be evaluated is highlighted in the same manner as described above in reference to highlighting the first set of reels 140a. The second set of reels 140b includes two of the columns 114b and 114c from the first set of reels 140a and one new or additional column (e.g., the fourth column 114d). The new/additional column 114d is adjacent to the first set of reels 140a. After the evaluation window 145 is moved such that it highlights the second set of reels 140b, the reel in the fourth column 114d is stopped such that the second sub-outcome is indicated by the second set of reels 140b.

The second sub-outcome builds partially on the first sub-outcome shown in FIG. 4A, as two of the three reels that comprise the second sub-outcome are from the first sub-outcome. That is, the symbols in the second and thirds columns 114b and 114c do not change as compared to the first sub-outcome when evaluated as a part of the second sub-outcome (FIG. 4B). The second sub-outcome is evaluated to determine if it is a winning outcome in the same manner as described above in reference to the first sub-outcome.

As shown, there are three like symbols 120a within the evaluation window 145 in FIG. 4B, thus, the second sub-outcome is a winning outcome. An indication 160b of the amount won based on the second sub-outcome is displayed below the evaluation window 145 in the same manner as described above in reference to the indication 160a. However, in the instant example, the amount won is indicated to be 10×2. The “10” in the indication 160b is the same as described above; however, the “2” in the indication 160b refers to a second multiplier 170b. The second multiplier 170b is a 2× multiplier, which means that the award of 10 credits achieved based on the second sub-outcome is multiplied by a 2× multiplier. Thus, the total award based on the second sub-outcome is twenty credits. This twenty credits is added to the previously awarded ten credits based on the first sub-outcome and shown in the credit win window 180 as a total award amount of thirty credits achieved thus far during the first play of the wagering game.

Because the second sub-outcome indicated by the second set of reels 140b is a winning outcome, the first play of the wagering game continues as shown in FIG. 4C. Prior to displaying a third sub-outcome (FIG. 4C), the evaluation window 145 moves and/or slides again one position or column to the right such that a third set of reels 140c (FIG. 4C) to be evaluated is highlighted. The third set of reels 140c includes two of the columns 114c and 114d from the second set of reels 140b (where one of those columns 114c is also from the first set of reels 140a), and one new or additional column (e.g., the fifth column 114e). After the evaluation window 145 is moved such that it highlights the third set of reels 140c, the reel in the fifth column 114e is stopped such that the third sub-outcome is indicated by the third set of reels 140c. The third sub-outcome is evaluated to determine if it is a winning outcome.

As shown, there are three like symbols 120a within the evaluation window 145 in FIG. 4C, thus, the third sub-outcome is a winning outcome. An indication 160c of the amount won based on the third sub-outcome is displayed below the evaluation window 145. In the instant example, the amount won is indicated to be 10×3. The “10” in the indication 160c is the same as described above; however, the “3” in the indication 160c refers to a third multiplier 170c. Thus, the total award based on the third sub-outcome is thirty credits. This thirty credits is added to the previously awarded ten and twenty credits based on the first and the second sub-outcomes, respectively, and shown in the credit win window 180 as a total award amount of sixty credits achieved thus far during the first play of the wagering game.

A review of the winning sub-outcomes thus far during the first play of the wagering game indicates that each of the winning sub-outcomes is based on three like symbols 120a appearing in a middle symbol position 112 in each of the columns 114a-e. However, as mentioned above, a winning sub-outcome only requires three like symbols 120a, that is, the three like symbols 120a need not appear in a row, as shown thus far, to be a winning sub-outcome. Such is the case in the fourth sub-outcome shown in FIG. 4D.

Because the third sub-outcome indicated by the third set of reels 140c is a winning outcome, the first play of the wagering game continues as shown in FIG. 4D. Prior to displaying a fourth sub-outcome (FIG. 4D), the evaluation window 145 moves and/or slides again one position or column to the right such that a fourth set of reels 140d (FIG. 4D) to be evaluated is highlighted. The fourth set of reels 140d includes two of the columns 114d and 114e from the third set of reels 140c (where one of those columns 114d is also from the second set of reels 140b), and one new or additional column (e.g., the sixth column 1140. After the evaluation window 145 is moved such that it highlights the fourth set of reels 140d, the reel in the sixth column 114f is stopped such that the fourth sub-outcome is indicated by the fourth set of reels 140d. The fourth sub-outcome is evaluated to determine if it is a winning outcome in the same manner as described above.

As shown, there are three like symbols 120a scattered within the evaluation window 145 in FIG. 4D, thus, the fourth sub-outcome is a winning outcome. An indication 160d of the amount won based on the fourth sub-outcome is displayed below the evaluation window 145 in the same manner as described above in reference to the indications 160a-c. In the instant example, the amount won is indicated to be 10×5. The “10” in the indication 160d is the same as described above; however, the “5” in the indication 160d refers to a fourth multiplier 170d. Thus, the total award based on the fourth sub-outcome is fifty credits. This fifty credits is added to the previously awarded credits and shown in the credit win window 180 of FIG. 4D as a total award amount of one hundred and ten credits achieved thus far during the first play of the wagering game.

Thus far, each of the sets of reels 140a-d has provided only one winning sub-outcome based on three like symbols 120a. However, one or more of the sets of reels described herein can provide more than one winning sub-outcome. Such is the case in the fifth set of reels 140e shown in FIGS. 4E and 4F.

Because the fourth sub-outcome indicated by the fourth set of reels 140d is a winning outcome, the first play of the wagering game continues as shown in FIGS. 4E and 4F. Prior to displaying a fifth sub-outcome (FIGS. 4E and 4F), the evaluation window 145 moves and/or slides again one position or column to the right such that a fifth set of reels 140e (FIGS. 4E and 4F) to be evaluated is highlighted. The fifth set of reels 140e includes two of the columns 114e and 114f from the fourth set of reels 140d (where one of those columns 114e is also from the third set of reels 140c), and one new or additional column (e.g., the seventh column 114g). The fifth sub-outcome is evaluated to determine if it is a winning outcome in the same manner as described above.

As shown, there are two different sets of three like symbols 120a (FIG. 4F) and 120b (FIG. 4E) scattered within the evaluation window 145 in FIGS. 4E and 4F, thus, the fifth sub-outcome is a winning outcome. Indications 160e and 160f of the amounts won based on both sets of like symbols 120a and 120b in the fifth sub-outcome are displayed below the evaluation window 145. In the instant example, the amount won for the first set is indicated to be 10×10 and the amount won for the second set is also indicated to be 10×10. The second “10” in the indications 160e and 160f refers to a fifth multiplier 170e. Thus, the total award based on the first set in the fifth sub-outcome is one hundred credits and the total award based on the second set in the fifth sub-outcome is also one hundred credits. The first one hundred credits is added to the previously awarded credits and is shown in the credit win window 180 as a total award amount of two hundred and ten credits achieved thus far in FIG. 4E and the second one hundred credits is added to the previously awarded credits and is shown in the credit win window 180 as a total award amount of three hundred and ten credits achieved thus far in FIG. 4F during the first play of the wagering game.

Because the fifth sub-outcome indicated by the fifth set of reels 140e is a winning outcome, the first play of the wagering game continues as shown in FIG. 4G. Prior to displaying a sixth sub-outcome (FIG. 4G), the evaluation window 145 moves and/or slides again one position or column to the right such that a sixth set of reels 140f (FIG. 4G) to be evaluated is highlighted. The sixth set of reels 140f includes two of the columns 114f and 114g from the fifth set of reels 140e (where one of those columns 114f is also from the fourth set of reels 140d), and one new or additional column (e.g., the eight column 114h). The sixth sub-outcome is evaluated to determine if it is a winning outcome in the same manner as described above.

As shown, there are three like symbols 120a scattered within the evaluation window 145 in FIG. 4G, thus, the sixth sub-outcome is a winning outcome. An indication 160g of the amount won based on the sixth sub-outcome is displayed below the evaluation window 145. In the instant example, the amount won is indicated to be 10×15. The “15” in the indication 160g refers to a sixth multiplier 170f. Thus, the total award based on the sixth sub-outcome is one hundred-fifty credits. This one hundred-fifty credits is added to the previously awarded credits and shown in the credit win window 180 of FIG. 4G as a total award amount of four hundred-sixty credits achieved thus far during the first play of the wagering game.

Thus far, each of the winning sub-outcomes is based on three like symbols 120a or 120b associated with an award value of ten credits. However, as mentioned above, the award value associated with one or more of the symbols 120 can be more or less than ten credits (e.g., 1 credit, 5 credits, 20 credits, 50 credits etc.) Such is the case in the seventh set of reels 140g shown in FIG. 4H.

Because the sixth sub-outcome indicated by the sixth set of reels 140f is a winning outcome, the first play of the wagering game continues as shown in FIG. 4H. Prior to displaying a seventh sub-outcome (FIG. 4H), the evaluation window 145 moves and/or slides again one position or column to the right such that a seventh set of reels 140g (FIG. 4H) to be evaluated is highlighted. The seventh set of reels 140g includes two of the columns 114g and 114h from the sixth set of reels 140f (where one of those columns 114g is also from the fifth set of reels 140e), and one new or additional column (e.g., the ninth column 114i). The seventh sub-outcome is evaluated to determine if it is a winning outcome in the same manner as described above.

As shown, there are three like symbols 120c scattered within the evaluation window 145 in FIG. 4H, thus, the seventh sub-outcome is a winning outcome. An indication 160h of the amount won based on the seventh sub-outcome is displayed below the evaluation window 145. In the instant example, the amount won is indicated to be 20×25. The “20” in the indication 160h refers to an amount of credits or coins associated with the symbols 120c that triggered the winning sub-outcome. As the “7” symbol is deemed to be more valuable in the instant example than the other symbols (e.g., ruby symbol, etc.), a higher award is associated therewith (e.g., 20 credits as compared with 10 credits). The “25” in the indication 160h refers to a seventh multiplier 170g. Thus, the total award based on the seventh sub-outcome is five hundred credits. This five hundred credits is added to the previously awarded credits and shown in the credit win window 180 of FIG. 4H as a total award amount of nine hundred-sixty credits achieved thus far during the first play of the wagering game.

Because the seventh sub-outcome indicated by the seventh set of reels 140g is a winning outcome, the first play of the wagering game continues as shown in FIG. 4I. The evaluation window 145 moves and/or slides again one position or column to the right such that at least a bonus reel in the tenth column 114j to be evaluated is highlighted. The bonus reel includes various bonus symbols associated with bonus awards. For example, a 10 credit bonus symbol is associated with a 10 credit award. Alternatively, the bonus reel can include bonus symbols such as high award values, wild symbols, blank symbols (e.g., no symbol in a symbol position), bonus game triggers, random multipliers for some or all of the prior winning sub-outcomes, progressive triggers, etc. The bonus reel is a bonus feature that is activated when the bonus reel is reached by the evaluation window 145. That is, if the previous sub-outcomes of the first play of the wagering game all result in winning outcomes, as shown and described above, the bonus reel is activated such that a player has an opportunity to win additional credits and/or awards based on an outcome of the bonus reel. The bonus reel in the tenth column 114j is evaluated to determine if it is a winning bonus outcome.

As shown, a 100 credit bonus symbol is randomly displayed within the evaluation window 145 in FIG. 4I, thus, the bonus reel outcome is a winning outcome. Alternatively, no bonus symbol can appear within the evaluation window 145, which would result in a losing bonus reel outcome. Thus, the total award based on the bonus reel outcome is one hundred credits. This one hundred credits is added to the previously awarded credits and shown in the credit win window 180 of FIG. 4I as a total award amount of one thousand and sixty credits achieved thus far during the first play of the wagering game. The displaying of a bonus reel outcome concludes the first play of the wagering game. Thus, the achieved credits during the first play of the wagering game (1060 credits) are awarded to the player and added to the credits in the credit window 185 as a total credit amount of one thousand one hundred and thirty-five credits (FIG. 4I).

Alternatively to FIG. 4I, instead of the bonus reel outcome including a 100 credit bonus symbol, the bonus reel can be a part of an eighth set of reels 140h to be evaluated, where the bonus reel includes a wild symbol as shown in FIG. 4J. As shown, there are three like symbols including two “7” symbols 120c and one wild symbol 120d scattered within the evaluation window 145 in FIG. 4J, thus, an eighth sub-outcome is a winning outcome. An indication 160i of the amount won based on the eighth sub-outcome is displayed below the evaluation window 145. In the instant example, the amount won is indicated to be 20×100. The “20” in the indication 160i refers to an amount of credits or coins associated with the symbols 120c and 120d that triggered the winning sub-outcome. As the “7” symbol is deemed to be more valuable in the instant example than the other symbols (e.g., ruby symbol, etc.), a higher award is associated therewith (e.g., 20 credits as compared with 10 credits). Additionally, the wild symbol 120d assumes the same value as the “7” symbols. The “100” in the indication 160i refers to a bonus reel multiplier 170h.

Thus, the total award based on the eighth sub-outcome is two thousand credits. This two thousand credits is added to the previously awarded credits and shown in the credit win window 180 of FIG. 4J as a total award amount of two thousand nine hundred-sixty credits achieved during the play of the wagering game. The displaying of a bonus reel outcome concludes the first play of the wagering game. Thus, the achieved credits during the first play of the wagering game (2960 credits) are awarded to the player and added to the credits in the credit window 185 as a total credit amount of three thousand and thirty-five credits (FIG. 4J).

Various alternatives ways of activating and/or triggering the bonus reel are possible. For example, a trigger symbol appearing in any one of the sub-outcomes during play of the wagering game can cause the bonus reel to be activated such that the player is given an opportunity to win a bonus award even if the player does not achieve a winning sub-outcome in each possible set of reels (e.g., each of sets of reels 140a-g). For another example, in response to a predetermined number (e.g., 1, 2, 3, all, etc.) of the sub-outcomes being winning sub-outcomes, the bonus reel can be activated.

While the various sets of reels 140a-g are described as being highlighted by (1) surrounding the set of reels with an evaluation window 145 and/or (2) enlarging the set of reels as described above, various alternative methods of highlighting a set of reels are contemplated, such as, for example, a set of reels can be highlighted by changing the color of the reels. Alternatively, a set of reels can be highlighted by stopping the reels within that set of reels and evaluating a sub-outcome of that set of reels while the rest of the reels continue to spin.

While the FIGS. and the above description illustrate the various sets of the reels 140a-140h as being highlighted (e.g., by an evaluation window and/or by being enlarged), the sets of the reels 140a-140h do not need to be physically highlighted. That is, for example, highlighting a first set of reels can occur without visually differentiating the reels in the first set from the other reels. In such an example, the reels in the first set are simply stopped and evaluated prior to stopping and evaluating any other sub-outcome.

Alternatively to subsequent sub-outcomes building partially on the previous sub-outcomes (i.e., the symbols in the first two columns of a subsequent sub-outcome do not change as compared to the immediately preceding sub-outcome), a subsequent sub-outcome need not build on a previous sub-outcome. In such an alternative concept, each time the evaluation window moves to highlight a subsequent set of reels, all of the reels within the evaluation window spin and randomly stop to display a sub-outcome that is evaluated.

As described above in reference to FIG. 4A, the wagering game can end without awarding anything to a player of the wagering game. In such an example, the rest of the reels (e.g., in columns 114d j) can stop spinning and display an outcome for those reels that the player could have achieved if the play continued. Alternatively to the player of the wagering game winning nothing, subsequent to all of the reels stopping and displaying the outcome for the entire array of symbol positions 110, the entire array of symbol positions 110 can be evaluated for bonus symbols (e.g., free spin symbols). In such an example, if a predetermined number of bonus symbols are displayed, a bonus award is achieved by the player, such as, for example, one or more free plays of the wagering game.

Alternatively to evaluating the entire array of symbol positions 110 for bonus symbols, a sub-outcome within the evaluation window 145 can be evaluated for a predetermined number of bonus symbols. In such an alternative example, if a predetermined number of bonus symbols are displayed within the evaluation window 145 for a given sub-outcome, a bonus award is achieved by the player, such as, for example, one or more free plays of the wagering game, an amount of credits, etc. Such a bonus award can be multiplied by a corresponding one of the multipliers 170a-g. For example, if a player wins a bonus award of 2 free plays and the multiplier associated with the evaluation window 145 encompassing the sub-outcome is a 5× multiplier, the bonus award would be 2 free plays times 5 or 10 free plays. For another example, if a player wins a bonus award of 2 free plays and the multiplier associated with the evaluation window 145 encompassing the sub-outcome is a 5× multiplier, the bonus award would be 2 free plays at a 5× multiplier such that any award achieved in the 2 free plays is multiplied by a 5× multiplier.

While the multipliers 170a-g are described herein as being specific multipliers that increase in integer value from the first column 114a to the ninth and/or tenth columns 114i,j, in some alternative concepts, the values of the multipliers 170a-g can be any integer value in any order. For example, the first multiplier 170a can be 1×, the second multiplier 170b can be 2×, and the third multiplier 170c can be 3×, 4×, 5×, 10×, etc.

In some alternative concepts of the present disclosure, a bonus award can be triggered based on a predetermined number of bonus symbols appearing in the various sub-outcomes of a single play of the wagering game. For example, three bonus symbols in three sub-outcomes can trigger a bonus award, such as, a free play. Thus, in response to three or more bonus symbols being included in any three sub-outcomes during a single play of the wagering game, a bonus award can be achieved by the player.

According to an alternative concept of bonus features described herein, while conducting a play of the wagering game described above in reference to FIGS. 4A-4J, one or more free plays of the wager game can be triggered and awarded to the player as a bonus feature. In such an alternative concept, each of the one or more free plays of the bonus features is limited and/or conducted based on the number of winning sub-outcomes achieved in the base game of the wagering game that lead to the triggering of the bonus feature. For example, a first play of the wagering game described above in reference to FIGS. 4A-4J is conducted. The first four sub-outcomes (e.g., FIGS. 4A-4D) of the wagering game are wining outcomes but the fifth sub-outcome is a losing outcome (not shown). In response to the first play of the wagering game triggering a bonus feature, for example, 10 free plays, each of the free plays is conducted to include a maximum of only four sub-outcomes, even though the array of symbol positions used in conducting the free plays includes additional reels that could otherwise be used to conduct more than four sub-outcomes in accordance with the concepts described above.

According to an alternative concept of described aspects, a single scatter feature (e.g., a bonus or special symbol) can be combined with the above disclosed concepts. For example, according to such alternative concepts, if a single scatter symbol (not shown) is displayed within the evaluation window 145 such that a first sub-outcome includes the single scatter symbol, regardless of whether the first sub-outcome is a winning outcome according to the above-described concepts, the evaluation window 145 is advanced, for example, to the right, and additional sub-outcomes are displayed/achieved until (1) the sub-outcome is a losing sub-outcome and (2) the sub-outcome excludes all single scatter symbols (i.e., no single scatter symbols appear in the sub-outcome), or until the evaluation window 145 reaches the last column in the array of symbol positions 110. According to such an alternative concept, the player of the wagering game employing the single scatter feature is able to prolong a single play of the wagering game without a sub-outcome being a winning outcome, so long as each sub-outcome at least includes a single scatter symbol, which provides the player with additional sub-outcome(s) having more opportunities to win. In addition to advancing the evaluation window, an award can also be provided to the player based on the single scatter symbol appearing in a sub-outcome (e.g., credits).

Similar to the single scatter feature, an alternative double scatter feature can be combined with the above disclosed concepts in the same, or similar, manner as the single scatter feature. For example, according to such alternative concepts, if two double scatter symbols (not shown) are displayed within the evaluation window 145 such that a first sub-outcome includes the two double scatter symbols, regardless of whether the first sub-outcome is a winning outcome according to the above-described concepts, the evaluation window 145 is advanced, for example, to the right, and additional sub-outcomes are displayed/achieved until (1) the sub-outcome is a losing sub-outcome and (2) the sub-outcome includes fewer than two double scatter symbols (i.e., one or zero double scatter symbols appear in the sub-outcome), or until the evaluation window 145 reaches the last column in the array of symbol positions 110. According to such an alternative concept, the player of the wagering game employing the double scatter feature is able to prolong a single play of the wagering game without a sub-outcome being a winning outcome, so long as each sub-outcome at least includes at least two double scatter symbols, which provides the player with additional sub-outcome(s) having more opportunities to win. In addition to advancing the evaluation window, an award can also be provided to the player based on two or more double scatter symbols appearing in a sub-outcome (e.g., credits).

Each of the winning outcomes described herein is contained in a paytable of the wagering game and has an associated award value (e.g., 20 credits, 100 credits, etc.). According to some implementations of the present concepts, the paytable and the award values therein of each associated winning outcome remains constant throughout the play of the wagering game. However, the award values can be modified by one or more multipliers (e.g., multiplier 170a-h)

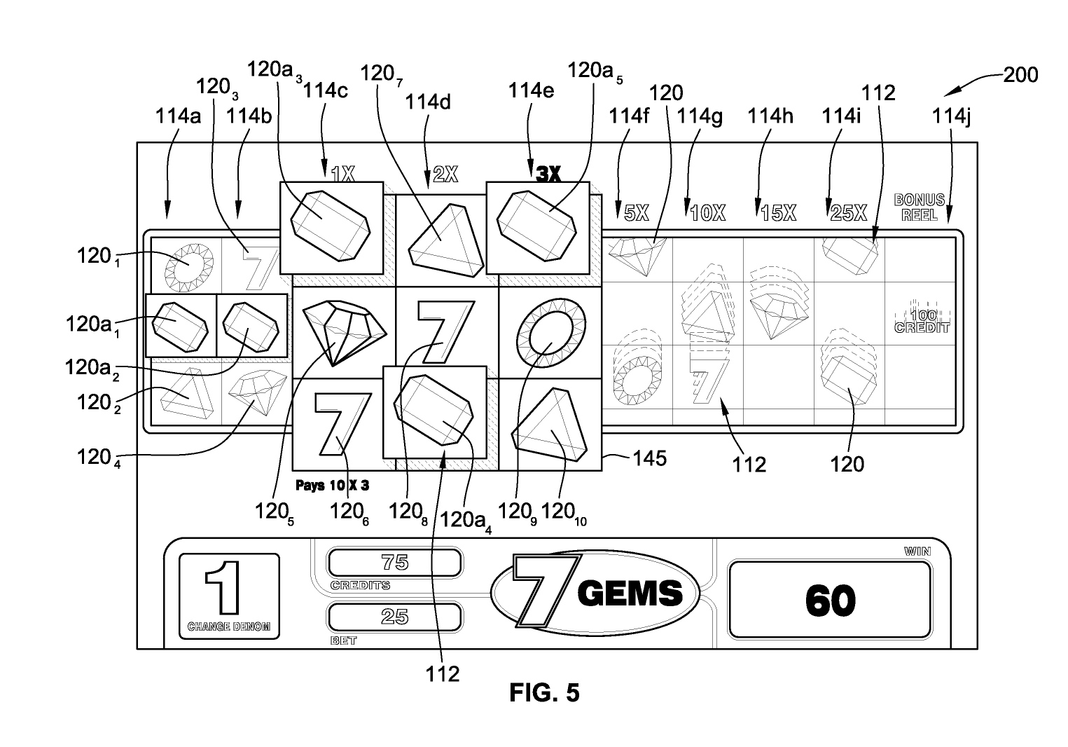

Referring to FIG. 5, an alternative aspect of displaying the winning sub-outcomes on the primary and/or secondary display areas 12, 14 described herein is shown. As described above in reference to FIG. 4C, there are three like symbols 120a within the evaluation window 145 in FIG. 4C forming the third winning sub-outcome. As a winning sub-outcome only requires three like symbols 120a that need not appear in a row (e.g., can be scattered within the evaluation window 145 as shown in FIG. 5), a player's ability to readily understand and/or view what symbols formed each winning sub-outcome during the play of the wagering game can be difficult. In order to increase a player's ability to follow the winning sub-outcome(s) during the play and increase the player's excitement and anticipation, the symbols 120a that form a winning sub-outcome can be raised and/or lowered to one or more different virtual planes of the primary and/or secondary display areas 12, 14.

The one or more virtual planes can be displayed on the same physical display or on a combination of two or more physical displays (e.g., using one or more transmissive displays). For example, if one physical display is used to display two or more virtual planes, the one display can virtually illustrate different virtual planes on the same display. For another example, if two displays are used, one display overlays the other and is offset therefrom in a Z direction (where each of the displays lies substantially in a respective plane formed in an X-Y plane). Thus, a first one of the displays lies in a first X-Y plane and the second one of the displays lies in a second X-Y plane that is offset from the first display in the Z direction.

As shown in FIG. 5, a screenshot 200 of a third winning sub-outcome, similar to the screenshot 100c illustrating the third winning sub-outcome of FIG. 4C, is shown. In addition to all of the shown and described aspects of FIG. 4C, FIG. 5 further includes a “3D win” feature that raises all of the symbols 120a (e.g., winning symbols) that contribute to a winning sub-outcome to a different virtual plane. For example, the symbol 120a₁ (e.g., winning symbol) in the first column 114a that previously contributed to the first winning sub-outcome is raised into a second virtual plane as compared to the symbols 120_{1,2} (e.g., non-winning symbols) in the first column 114a that did not contribute to the first winning sub-outcome. Similarly, the symbol 120a₂ in the second column 114b that previously contributed to the first and the second winning sub-outcomes is raised into the second virtual plane as compared to the symbols 120₁₋₄ in the first and the second columns 114a,b that did not contribute to the first or the second winning sub-outcomes.

By the term raised into a different virtual plane it is meant that a symbol 120 and/or symbol position 112 is visually altered to appear to be closer to the player of the wagering game as compared to the symbol and/or symbol position before it was raised. Put another way, the symbol 120 and/or symbol position 112 is physically translated (e.g., multiple layered and/or transmissive displays) and/or virtually translated (e.g., single display) along a Z-axis wherein the primary and/or secondary display areas 12, 14 lie in a plane defined by the X and Y axes and wherein each of the virtual planes is defined by a plane defined by the X and Y axes (e.g., single display) or by respective planes that lie in two or more X-Y planes along a common Z-axis (e.g., multiple layered and/or transmissive displays).

The symbols 120 of the third winning sub-outcome in the third to fifth columns 114c-e in the evaluation window 145 are all raised as compared to the symbols 120a_{1,2} and 120₁₋₄ in the first and the second columns 114a,b and as compared to the spinning symbols 120 in the sixth to tenth columns 114f-j. Specifically, the symbols 120₅₋₁₀ in the third, fourth, and fifth columns 114c-e that do not contribute to the third winning sub-outcome are in a third virtual plane and the symbols 120a₃₋₅ in the third, fourth, and fifth columns 114c-e that do contribute to the third winning sub-outcome are each raised into a fourth virtual plane as compared to the symbols 120₅₋₁₀. The spinning symbols 120 in the sixth to tenth columns 114f-j are also in the first virtual plane along with the symbols 120₁₋₄.

While four separate and distinct virtual planes are shown and described herein, various other numbers of virtual planes are possible. For example, a two virtual-plane concept can be implemented where all symbols that contribute to a winning sub-outcome are raised to a second virtual plane and all symbols that do not contribute to a winning sub-outcome remain in a relatively lower first virtual plane. For another example, the columns that are in the evaluation window 145 are highlighted by being located in a first virtual plane, the prior winning symbols and/or associated symbol positions are positioned in a second virtual plane, set back from (e.g., lowered) the first virtual plane, and all non-winning symbols and columns yet to enter the evaluation window 145 are positioned in a third virtual plane, set back from (e.g., lowered) both the first virtual plane and the second virtual plane. Thus, the reels within the evaluation window 145 can be highlighted as compared to the other reels not within the evaluation window 145 by visually displaying the reels therein in a different virtual plane than the other reels.

Each of the above embodiments and obvious variations thereof is contemplated as falling within the spirit and scope of the claimed invention, which is set forth in the following claims.

What is claimed is:

1. A method for conducting a wagering game via a gaming terminal, the method comprising:
receiving, via an input device, a wager to play the wagering game;
displaying, on one or more display devices, a plurality of symbol-bearing reels arranged in a plurality of adjacent columns;
highlighting, on the one or more display devices, a first set of reels to be evaluated;
spinning the reels and stopping the first set of reels such that a first randomly selected outcome is indicated by the first set of reels;
evaluating the first outcome to determine if the first outcome is a winning outcome; and
in response to the first outcome being a winning outcome, (i) providing a first award having a first multiplier level associated therewith; (ii) highlighting a second set of reels to be evaluated, the second set of reels including at least one of the reels of the first set of reels and one of the reels that is adjacent to the first set of reels; (iii) stopping the one of the reels that is adjacent to the first set of reels such that a second randomly selected outcome is indicated by the second set of reels; (iv) evaluating the second outcome to determine if the second outcome is a winning outcome; and (v) in response to the second outcome being a winning outcome, providing a second award having a second multiplier level associated therewith that is greater than the first multiplier level.

2. The method of claim 1, wherein the highlighting the first set of reels includes surrounding the first set of reels with an evaluation window.

3. The method of claim 2, further comprising, in response to the first outcome being a winning outcome, moving the evaluation window such that the evaluation window surrounds the second set of reels thereby highlighting the second set of reels.

4. The method of claim 1, wherein the highlighting the first set of reels includes virtually displaying the first set of reels in a different virtual plane than the other reels.

5. The method of claim 1, wherein the highlighting the first set of reels includes enlarging the first set of reels at least during the evaluation of the first outcome.

6. The method of claim 1, further comprising in response to the second outcome being a winning outcome, (i) highlighting a third set of reels to be evaluated, the third set of reels including at least one reel from the first set of reels, at least two reels from the second set of reels and one of the reels that is adjacent to the second set of reels; (ii) stopping the one of the reels that is adjacent to the second set of reels such that a third randomly selected outcome is indicated by the third set of reels; (iii) evaluating the third outcome to determine if the third outcome is a winning outcome; and (iv) in response to the third outcome being a winning outcome, providing a third award having a third multiplier level associated therewith that is greater than the first multiplier level and the second multiplier level.

7. The method of claim 1, wherein the first outcome is formed by winning symbols and non-winning symbols, the method further comprises lowering the non-winning symbols from a first virtual plane to a second virtual plane.

8. The method of claim 1, wherein winning outcomes are contained within a paytable having an award value associated with the winning outcomes, the paytable remaining constant for the first evaluation and the second evaluation.

9. A method for conducting a wagering game via a gaming terminal, the method comprising:
receiving, via an input device, a wager to play the wagering game;
displaying, on one or more display devices, an array of symbol positions arranged in a plurality of columns;
randomly distributing a plurality of symbols such that each of the symbol positions in a first portion of the array of symbol positions is associated with one or more of the plurality of symbols thereby forming a first partial-outcome;
evaluating the first partial-outcome to determine if the first partial-outcome is a winning partial-outcome; and
in response to the first partial-outcome being a winning partial-outcome, (i) providing a first award having a first multiplier level; (ii) randomly distributing a portion of the plurality of symbols such that each of the symbol positions in a first one of the columns adjacent to the first partial-outcome is associated with one or more of the plurality of symbols, a portion of the first partial-outcome and the first one of the adjacent columns forming a second partial-outcome; (iii) evaluating the second partial-outcome to determine if the second partial-outcome is a winning partial-outcome; and (iv) in response to the second partial-outcome being a winning partial-outcome, providing a second award having a second multiplier level that is greater than the first multiplier level.

10. The method of claim 9, further comprising in response to the second partial-outcome being a winning partial-outcome, (i) randomly distributing a portion of the plurality of symbols such that each of the symbol positions in a second one of the columns adjacent to the first one of the adjacent columns is associated with one or more of the plurality of symbols, a portion of the first partial-outcome, the first one of the adjacent columns, and the second one of the adjacent columns forming a third partial-outcome; and (ii) evaluating the third partial-outcome to determine if the third partial-outcome is a winning partial-outcome.

11. The method of claim 10, further comprising in response to the third partial-outcome being a winning partial-outcome, providing a third award at a third multiplier level that is higher than the first and the second multiplier levels.

12. The method of claim 11, wherein the first multiplier level is a 1× multiplier, the second multiplier level is a 2× multiplier, and the third multiplier level is a multiplier with an integer value greater than 2×.

13. The method of claim 9, wherein the array of symbol positions is formed by a plurality of symbol-bearing reels, each of the columns being occupied by a single one of the reels.

14. A method for conducting a wagering game via a gaming terminal, the method comprising:
receiving, via an input device, a wager to play the wagering game;
displaying, on one or more display devices, a plurality of symbol-bearing reels arranged in a plurality of adjacent columns, one of the reels being a bonus reel bearing bonus symbols;
highlighting, on the one or more display devices, a first portion of the reels to be evaluated, the first portion of the reels not including the bonus reel;
spinning the reels and stopping the first portion of the reels such that a first randomly selected outcome is indicated by the first portion of the reels;
evaluating the first outcome to determine if the first outcome is a winning outcome;
in response to the first outcome being a winning outcome, (i) providing a first award; (ii) highlighting a second portion of the reels to be evaluated, the second portion of the reels not including the bonus reel, the second portion of the reels including at least one of the reels of the first portion of the reels and one of the reels that is adjacent to the first portion of the reels; (iii) stopping the one of the reels that is adjacent to the first portion of the reels such that a second randomly selected outcome is indicated by the second portion of the reels; and (iv) evaluating the second outcome to determine if the second outcome is a winning outcome; and
in response to the second outcome being a winning outcome, activating the bonus reel.

15. The method of claim 14, wherein the activating further comprises (i) highlighting at least the bonus reel; (ii) stopping the bonus reel such that a randomly selected bonus outcome is indicated by the bonus reel; (iii) evaluating the bonus outcome to determine if the bonus outcome is a winning bonus outcome; and (iv) in response to the bonus outcome being a winning bonus outcome, providing a bonus award.

16. The method of claim 15, wherein the bonus award is a credit award, a cash award, a multiplier, a bonus game trigger, a progressive trigger, a high value symbol, or any combination thereof.

17. A gaming system comprising:
at least one input device;
at least one display device;
at least one processor;
at least one memory device storing instructions that, when executed by the at least one processor, cause the gaming system to:
receive a wager to play a wagering game;
display a plurality of symbol-bearing reels arranged in a plurality of adjacent columns;
highlight a first set of reels to be evaluated;
spin the reels and stop the first set of reels such that a first randomly selected outcome is indicated by the first set of reels;
evaluate the first outcome to determine if the first outcome is a winning outcome; and
in response to the first outcome being a winning outcome:
(i) provide a first award having a first multiplier level associated therewith;
(ii) highlight a second set of reels to be evaluated, the second set of reels including at least one of the reels of the first set of reels and one of the reels that is adjacent to the first set of reels;
(iii) stop the one of the reels that is adjacent to the first set of reels such that a second randomly selected outcome is indicated by the second set of reels;
(iv) evaluate the second outcome to determine if the second outcome is a winning outcome; and
(v) in response to the second outcome being a winning outcome, provide a second award having a second multiplier level associated therewith that is greater than the first multiplier level.

18. The system of claim 17, wherein the first outcome is formed by winning symbols and non-winning symbols, and in response to the first outcome being a winning outcome, the gaming system is further caused to lower the non-winning symbols from a first virtual plane to a second virtual plane.

19. The system of claim 18, wherein the gaming system is caused to lower the non-winning symbols from the first virtual plane to the second virtual plane by virtually translating the non-winning symbols along a Z-axis wherein the first and the second virtual planes are defined by X and Y axes.

20. The system of claim 17, wherein winning outcomes are contained within a paytable having an award value associated with the winning outcomes, the paytable remaining constant for the first evaluation and the second evaluation.
